(19) United States
(12) Patent Application Publication
(10) Pub. No.: US 2026/0275803 A1
(43) Pub. Date: Sep. 17, 2026

(54) DOOR, COMPARTMENT, METHOD FOR MANUFACTURING A DOOR, AND METHOD FOR MANUFACTURING SLATS OF A DOOR

(71) Applicant: F. LIST GMBH, Thomasberg (AT)

(72) Inventors: Martin Jagersberger, Thomasberg (AT); Birgit Bauer, Thomasberg (AT); Patrick Domnanich, Thomasberg (AT); Christoph Handler, Thomasberg (AT)

(73) Assignee: F. LIST GMBH, Thomasberg (AT)

(21) Appl. No.: 19/669,036

(22) Filed: May 6, 2026

Related U.S. Application Data
(63) Continuation of application No. PCT/EP2023/081540, filed on Nov. 10, 2023.

(51) Int. Cl. E06B 9/15; E06B 9/11; E06B 9/58; E06B 9/17

(52) U.S. Cl. CPC E06B 9/15; E06B 9/115; E06B 9/581; E06B 2009/1555; E06B 2009/17092

(57) ABSTRACT

A door configured to be slidably attached to a body to slidably open and close an opening of the body, as well as an associated compartment and methods for manufacture, are disclosed. The door includes a plurality of slats and a flexible connecting layer, the slats being fixedly attached to a first side of the connecting layer which faces an interior of the body. The door includes a flexible outer layer attached to a second side of the connecting layer which faces an exterior of the body. The door includes at least one guide element which is connected to one of the slats and is arranged on a side of the slat(s) which faces the interior of the body. The guide element is configured to cooperate with a counter guide element of the body to guide the door, when the door is slidably opened and/or closed.

### CROSS REFERENCE TO RELATED APPLICATION

This application is a continuation of International Application No. PCT/EP2023/081540, filed Nov. 10, 2023, which is incorporated by reference herein in its entirety.

### BACKGROUND

Compartments for storing one or more items are used in a variety of different fields. The compartments are available in a variety of different sizes and/or shapes, in particular depending on their purpose, the size(s) and/or shape(s) of the items to be stored in the respective compartment, and the available space in the respective environment in which the compartment is arranged or is to be arranged.

Most compartments include at least one door configured to at least partially close the respective compartment, e.g., in order to protect the interior of the compartment from external influences and/or to prevent the contents in the compartment from unintentionally being removed from the compartment. The doors may be openable and/or closeable by sliding and/or pivoting the respective door(s).

However, the doors known from the prior art have several disadvantages.

For instance, the pivoting doors known from the prior art are often configured to be substantially rigid. Hence, the pivoting doors are generally unable to adapt their shape, in particular by bending, which limits their use and/or field of applications. Thus, pivoting doors are particularly disadvantageous in more compact environments.

Sliding doors may be, in some cases, configured to be flexible, e.g., to allow the door to be bent as the door is being slid to open and/or close the compartment. For instance, tambour doors which include a plurality of slats arranged side by side may provide flexibility to the door to allow such bending of the respective door. However, the tambour doors known from the prior art are not considered to be particularly aesthetically appealing and/or are limited in their technical configuration and/or design. Moreover, the tambour doors known from the prior art may also be limited in their potential fields of application.

Thus, there remains a need to improve the doors known from the prior art, e.g., by improving and/or eliminating one or more drawbacks of the doors known from the prior art, e.g., one or more of the above-identified drawbacks.

### SUMMARY

It is therefore an object of the present invention to provide an improved door.

This object is achieved by a door as defined by the features of claim 1. Preferred embodiments are defined by the features of the respective dependent claims.

The door may be configured to be slidably attached to a body to slidably open and close at least one opening defined in the body. The body may be part of a structural element of a vehicle (e.g., an airplane, ship, bus, motorhome, etc.), furniture, or any other installation comprising one or more doors. The door may include a plurality of slats.

The door may include at least one connecting layer which may be at least partially flexible and may have a first side, which faces an interior of the body, and a second side, which faces an exterior of the body, when the door is attached to the body. In other words, the second side may be a viewing side, e.g., which is visible by a user, at least when the door is in a closed position on the body. The first side may not be visible to the user, at least when the door is in a closed position on the body. The first side may be substantially opposite from the second side. The slats may be fixedly attached to the first side of the connecting layer.

The door may include at least one outer layer which may be at least partially flexible. The outer layer may be fixedly attached to the second side of the connecting layer.

The door may include at least one guide element which is preferably connected to at least one of the slats. The guide element may be arranged at least partially, preferably completely, on a side of the slat(s) which faces the interior of the body, when the door is attached to the body. The guide element may be configured to cooperate, e.g., by engaging, with at least one counter guide element of the body to guide the door, when the door is slidably opened and/or closed.

Hence, the door according to the present disclosure may be configured such that the structure, i.e., the connecting layer, which interconnects the slats is arranged towards the exterior of the body, with respect to the slats. In other words, the slats may be arranged behind the connecting layer and the outer layer, when viewing the door from the exterior in a state in which the door is attached to the body. This may substantially hide the slats behind the connecting layer and the outer layer, when viewing the door from the exterior in a state in which the door is attached to the body, to provide a smoother and/or more aesthetically appealing appearance to the door. This may also make the door less prone to collection of media, e.g., dust, liquids, particles, etc., on the exterior of the door. By contrast, the doors provided with slats in the prior art are generally configured such that the slats are arranged on the outside of the respective connecting structure such that the slats are visible from the exterior.

Compared with pivoting doors, the door according to the present disclosure may flexibly adapt its shape, in particular by allowing bending of the door, in particular due to the above-described configuration with the slats, the flexible connecting layer, and the flexible outer layer, when opening and/or closing the door. This may make the door disclosed herein advantageous in particular for use in more compact spaces, in particular by occupying less space to open and close the door. Thus, for instance, the door disclosed herein may be particularly suited for use in aircraft and/or watercraft and/or land vehicles which generally have more compact interior spaces. To provide greater suitability for use in aircraft and/or watercraft, one or more components of the door may be treated with at least one flame retardant and/or may be configured to pass the vertical burn test, as discussed throughout the following description. The vertical burn test may be performed as defined by the U.S. Federal Aviation Administration (FAA) in the Code of Federal Regulations (CFR), more specifically in CFR Title 14, Chapter 1, Subchapter C, Appendix F to Part 25, Part I (a)(1)(i) in connection with CFR Title 14, Chapter 1, Subchapter C, Appendix F to Part 25, Part I (b)(4), also known as the 60 second vertical burn test. Additionally, or alternatively, the vertical burn test may be performed pursuant to CFR Title 14, Chapter 1, Subchapter C, Appendix F to Part 25, Part I (a)(1)(ii) in connection with CFR Title 14, Chapter 1, Subchapter C, Appendix F to Part 25, Part I (b)(4), also known as the 12 second vertical burn test. The version of the above-identified Code of Federal Regulations (CFR) which is in force on October 1, 2023 is to be applied.

The flexible outer layer may provide a structure which may be decoratively configured, e.g., by coating the outer layer, to provide a certain design to the exterior of the door. This may allow the connecting layer to be configured according to its primary purpose, namely to provide an interconnecting structure to the slats, substantially independently from decorative purposes, whereas the outer layer may be configured primarily for decorative and/or aesthetic purposes. For instance, the outer layer may include or provide one or more optical effects to enhance the visual of the door, e.g., via one or more colors, shine, gloss, glitter, and/or by preventing or at least reducing fingerprints on the exterior of the door, etc. Preferably, the flexible outer layer provides a continuous and uninterrupted outer surface with no gaps.

Moreover, arranging the guide element(s) at least partially, preferably completely, on the side of the slat(s) which faces the interior of the body may allow the lateral sides of the door, which extend substantially perpendicularly to the first side and/or the second side of the connecting layer and/or to a closing direction and/or an opening direction of the door, to be free of guide elements. By contrast, the doors with slats known from the prior art generally have respective guide elements, e.g., pins, which are connected to the lateral sides of the respective doors and/or the slats themselves, i.e., ends thereof, are used as guide elements which engage with respective grooves. For one, this may limit the arrangement and configuration of the corresponding counter guide element, e.g., a slot or groove. Moreover, this may make the respective guide element(s) and/or the corresponding counter guide element, e.g., a slot, more prone to external influences, e.g., dirt, fluids, particles, etc., in particular since the counter guide element is generally arranged relatively close to and/or at the opening in said prior art solutions. Thus, arranging the guide element(s) at least partially, preferably completely, on the side of the slat(s) which faces the interior of the body may provide greater protection to the guide element(s) and/or the corresponding counter guide element with respect to external influences, e.g., since the counter guide element(s) may be arranged further from the opening. Moreover, this may also at least partially hide the guide element(s) and/or the corresponding counter guide element from the user’s view, or at least increase a hiding effect compared with the prior art solutions, at least when the door is in a closed position, to increase the aesthetic appearance of the door. Moreover, this may also provide greater flexibility in configuring and/or shaping the guide element and/or the counter guide element of the body, by arranging an interface between the guide element and/or the counter guide element at a location which provides more space and/or more design flexibility, compared with being limited to an interface at the lateral sides of the doors and/or at the opening, as known from the prior art.

Advantageously, the door disclosed herein is configured to withstand frequent use and/or to have a relatively long lifetime. For instance, tambour doors are known to be used in automobiles which, however, generally have a shorter lifetime and/or lower quality expectations and/or less use than a watercraft and/or an aircraft and/or in a household. Hence, the door disclosed herein is configured to withstand greater use than the tambour doors known from the prior art. In particular, the door disclosed herein is configured to withstand a life cycle test which includes 50,000 cycles, each cycle including one opening and one closing movement, without showing failure and/or significant signs or fatigue which may compromise, or even prevent, the operation of the door.

The outer layer may be directly or indirectly, e.g., via at least one intermediate layer, connected to the connecting layer on the second side of the connecting layer.

The connecting layer may interconnect the outer layer and the slats.

The connecting layer may be adhesively bonded, e.g., glued, to the slats and/or the outer layer by means of at least one adhesive, e.g., by means of one or more of polyurethane adhesives, polyvinyl acetate adhesives, silicone adhesives, and neoprene adhesives. Preferably, the adhesive(s) includes a 1K or a 2K polyurethane adhesive and/or a hot melt adhesive.

Preferably, the connecting layer is configured to be self-adhesive.

The connecting layer may be a single layer. Alternatively, the connecting layer may be configured as a multi-layer structure, preferably including at least one layer of foam and/or at least one layer of fabric and/or textile and/or at least one layer of laminate.

The connecting layer may be made of one and/or may include one or more of the following materials: a foam, preferably an acrylic foam, and a laminate.

Including foam in the connecting layer may allow one or more stresses, e.g., shear stress, which may occur in flexible doors, in particular due to flexing and/or the different radii along the door, in particular between the outer surface and the inner surface of the door and the different materials used in the door, during opening and/or closing of the door, to be compensated and/or absorbed by the foam in the connecting layer.

The foam of the connecting layer may be a closed-cell structural foam, preferably a closed-cell thermoplastic structural foam which is recyclable. The foam may have a density between 0.5 g/cm3 and 2.5 g/cm3, preferably 0.5 g/cm3 and 2 g/cm3, more preferably 0,5 g/cm3 and 1.75 g/cm3, more preferably 0,5 g/cm3 and 1.5 g/cm3, more preferably 0.75 g/cm3 and 1.2 g/cm3. The flatwise E-module in the plane of the foam panel is preferably 50-175 N/mm², more preferably 70-110N/mm², most preferably 85-90 N/mm². The flatwise E-module for instance can by determined by ASTM C297. The tensile modulus measured perpendicular to the plane is preferably 100-250 MPa, more preferably 150-200MPa. The tensile modulus for instance can be determined by ASTM D1623.

The flatwise tensile strength of the foam panel is preferably 1-3 N/mm², more preferably 1.3-2.5N/mm². The flatwise tensile strength for instance can by determined by ASTM C297. The tensile strength measured perpendicular to the plane is preferably 2-40 MPa, more preferably 2-20MPa, more preferably 2-6 MPa, most preferably 3-5.5 MPa. The tensile strength for instance can be determined by ASTM D1623.

The compressive strength of the foam perpendicular to the plane is preferably 0.5-50MPa, more preferably 0.5-40 MPa, more preferably 0.5-4 N/mm², more preferably 0.7-3N/mm². The compressive strength for instance can by determined by ISO 844:2021 or by ASTM D1621. Surprisingly using foam with the properties described herein results in doors which are solid while retaining enough flexibility to bend and to pass the mentioned life-cycle requirements.

The laminate of the connecting layer may include kraft and/or aramide paper, resin, etc., in a composite structure. Preferably, the laminate may include melamine or melamine-formaldehyde resin and one or more decorative and/or kraft papers. The laminate may be a high-pressure laminate and/or or a continuous-pressure laminate, e.g., a laminate available from FRITZ EGGER GmbH & Co. OG in Austria, a laminate available from Fundermax GmbH in Austria, and/or a laminate available from any of the companies Resopal, Duropal, Formica, Wilsonart etc. The laminate may have a density of at least 1 g/cm3, preferably at least 1.35 g/cm3. Preferably the laminate is difficult to ignite, preferably is quality B1 – according to DIN 4102.

The connecting layer, in particular the foam and/or the laminate, may be treated with at least one flame retardant. The flame retardant may be organic or inorganic. Preferably, the flame retardant is a nitrogen-phosphorus compound.

The guide element(s) may be connected directly or indirectly, e.g., via at least one intermediate structure of layer, to the respective slat(s).

The guide element(s) may be arranged entirely on the side of the slat(s) which faces the interior of the body. In other words, the lateral sides of the door, which extend substantially perpendicularly to the first side and/or the second side of the connecting layer and/or to a closing direction and/or an opening direction of the door, may be free of any guide elements.

The guide element(s) may be bent and/or angled one or more times along the guide element. This may increase the flexibility of the arrangement and/or configuration of the counter guide element. Preferably, the guide-element is Z-shaped.

The guide element(s) may be adhesively attached, indirectly or directly, to the respective slat(s). Alternatively, or additionally, the guide element may be attached, indirectly or directly, to the slats via a frictional fit and/or form fit, e.g., via one or more pins and/or clips and/or screws.

The guide element(s) may be at least partially made of metal, e.g., aluminum, plastic, e.g., ABS, polyoxymethylene (POM), polypropylene, preferably POM.

The door may be configured to be opened and closed vertically, i.e., in an up-and-down manner, and/or horizontally, i.e., in a lateral or sideways manner.

One or more counter guide elements may be provided by the body. For instance, at least two counter guide elements may be provided, wherein a first counter guide element is provided on a first side of the body and a second counter guide element is provided on a second side of the body which is substantially opposite from the first side. The first and second sides of the body may be a top and a bottom panel of the body and/or lateral sides. In other words, the counter guide elements may extend vertically, in particular when the door is a vertically opening and closing door, or horizontally, in particular when the door is a horizontally opening and closing door.

Preferably, at least one counter guide element is provided on a bottom side of the body. Preferably, the counter guide element is provided on a bottom panel of the body, preferably on a side or surface of the bottom panel which faces away from the interior of the body. This may prevent media, e.g., water, dirt, etc., from entering the counter guide element, or at least reduce the risk and/or amount thereof. A top panel of the body may also include at least one counter guide element which may be provided on a side or surface of the top panel which faces away towards the interior of the body.

The counter guide element(s) may be integrally formed in the body, e.g., by milling one or more grooves into the body. Alternatively, the counter guide element(s) may be separate components which are attached to the body, wherein the counter guide element(s) may be made of wood, plastic, e.g., PP, PA, PVC, POM, etc., and/or metal, e.g., aluminum and/or steel, preferably aluminum or plastic. Integrally formed counter guide element(s), e.g., by milling one or more grooves into the body, may provide a simpler and quicker manufacturing process, in particular for more complex guiding paths. Thus, integrally formed counter guide element(s) may be advantageous for a door according to the present invention which opens horizontally/sideways. Counter guide element(s) which are configured as separate components may provide greater strength. Hence, counter guide element(s) which are configured as separate components may be used for a door to the present invention which opens vertically, i.e., up and down, which may have a less complex guiding path. This may also allow the door to be removed separately without dismantling the body. This may save time and costs in the event of a removal of the door, e.g., for replacement or maintenance.

The guide elements may have a coefficient of variation relative to each other of one or more dimensions of the guide elements, preferably at least of a diameter of the guide elements, preferably more specifically of at least of a diameter of engagement members of the guide elements, of less than 4%, preferably less than 3%, more preferably less than 1%. Surprisingly, larger tolerances lead to reduced running smoothness and premature material fatigue for less than 100,000 cycles.

Preferably, the door is configured to be opened such that: the entire door front remains on the exterior of the body and/or the door does not protrude into the interior of the body; and/or a distal end of the door, with respect to an opening direction of the door, remains on the exterior of the body.

This may prevent the door from interfering with the interior of the body, which may allow the compartment to be space-optimized. In particular, this allows to omit elements arranged in the interior of the body for receiving and/or supporting the door, when opening the door. Preferably, the door is at least partially slid behind the body, i.e., to a side of the body which faces away and/or opposite from the opening in the body, i.e., the opening which is closed by the door.

The guide element(s) may be configured to be releasably attached, preferably by means of at least one quick-release mechanism, e.g., a latch or the like, to the counter guide element(s). This may allow the door to be released in a relatively simple manner, e.g., to service the door or the body and/or to access one or more sections the body, e.g., storage space at the side(s) and/or back of the body.

The door is preferably configured such that side elements, e.g., side panels, of the body are substantially covered by the door, at least when the door is in a closed position, when viewing the door and the body from the front, i.e., from the second side, i.e., the viewing side. Thus, the side elements, e.g., side panels, of the body are substantially not visible in this state, which may enhance the aesthetic appeal of the door and body, e.g., by reducing the visible seams and/or edge-to-edge interfaces.

The body may include a top front panel arranged towards or at a top of the body. Preferably, the body contains or is made of furniture boards. For example it may contain chipboard, plywood board or osb panels with or without coating and/or decor. More preferably, for aircraft or watercraft use it may contain lightweight composites. Preferably those include honeycomb panels or sandwiches and/or foam panels or sandwiches. Honeycomb structure may for example be made of aramid or aluminum.

Preferably, the door is configured to be opened and closed vertically, i.e., in an up-and-down manner. Preferably, a lower side of the top front panel is arranged adjacent to a top side of the door, when the door is in a closed position. Preferably, the lower side of the top front panel is beveled, preferably such that a front portion of the lower side of the top front panel, which faces towards the exterior of the body, extends further towards a bottom of the body than a back portion of the lower side of the top front panel, l, which faces towards the interior of the body, when the door and the body are in an operating position. This may (further) enhance the aesthetic appeal of the door and body.

Preferably, the body includes at least two counter guide elements on each lateral side of the body. A first of the counter guide elements may extend along only a portion of a second of the counter guide elements, preferably at an end section of the second of the counter guide elements, with respect to an opening direction of the door. Surprisingly, the present inventors discovered that, for a vertically opening and closing door, providing only one guide rail on each lateral side of the body, caused the door to be bent, in particular at the top edge of the door, when opening and closing the door, which caused undesired visible horizontal lines in the decorative surface of the door. Providing a further counter guide element towards the upper portion substantially preventing buckling and said visible lines.

The door may include at least one edge member which covers one or more edges of the door. This may prevent the slats from being visible, e.g., in case one or more edges of the door are visible, e.g., when the door is open. This may (further) enhance the aesthetic appeal of the door and body. The edge member may be made of any suitable material, e.g., silicone, a thermoplastic elastomer, etc.

Preferably, an inner side of each slat which faces the interior of the body is free of any interconnection to at least one adjacent slat. In other words, no layer or other element, which connects the slats, is attached to the inner side of the slats. In other words, the inner side of each slat, except for the guide element(s), is contact-free, i.e., the inner side, where the guide elements(s) is/are not arranged, is exposed directly to the atmosphere in the interior of the body. Thus, the door according to the present disclosure may be capable of operably functioning, e.g., by opening and closing the door, without an inner layer which provides strength/structure/interconnection to the slats. This may make the door lighter and/or thinner and/or easier to close/open and/or more flexible.

Alternatively, an inner layer may be provided, e.g., to facilitate cleaning of the inner side of door. However, an inner layer it is not required for structural purposes.

Preferably, the door is configured to slidably open and close at least one opening in the body which has an area of at least 600 cm2, preferably at least 1000 cm2, more preferably at least 1400 cm2, more preferably at least 1800 cm2, more preferably at least 2200 cm2, more preferably at least 2600 cm2, more preferably at least 3000 cm2, more preferably at least 3400 cm2, more preferably at least 3800 cm2, more preferably at least 4200 cm2, more preferably at least 4600 cm2, more preferably at least 5000 cm2, more preferably at least 5400 cm2, more preferably at least 5800 cm2, more preferably at least 6200 cm2, more preferably at least 6700 cm2, more preferably at least 7200 cm2, more preferably at least 7600 cm2, more preferably at least 8000 cm2, more preferably at least 8500 cm2, more preferably at least 9000 cm2, more preferably at least 9500 cm2. In other words, the door according to the present disclosure may have the structural integrity to allow the door to be dimensioned and to slidably close and close openings having the above-recited area value(s). Many of the sliding doors known from the prior art are configured, i.e., dimensioned and structural configured, to open and close relatively small openings.

Preferably, the door is configured to slidably open and close at least one opening in the body which has a width, which extends in a direction which is substantially perpendicular to a closing direction and/or an opening direction of the door, between 10 and 150 cm, preferably between 20 and 140 cm, more preferably between 30 and 130 cm, more preferably between 40 and 130 cm, more preferably between 50 and 120 cm, more preferably between 60 and 110 cm, more preferably between 59 and 100 cm, in particular without structurally comprising the door, e.g., due to buckling, creasing, etc.

Preferably, the door is configured to slidably open and close at least one opening in the body which has a length, which extends in a direction along a closing direction and/or an opening direction of the door, of at least between 30 and 250 cm, preferably at least between 40 and 230 cm, more preferably at least between 50 and 220 cm, more preferably at least between 60 and 210 cm, more preferably at least between 70 and 200 cm, more preferably at least between 80 and 190 cm, more preferably at least 90 and 180 cm, more preferably at least between 90 and 180 cm, more preferably at least between 90 and 160 cm, more preferably at least between 100 and 150 cm, more preferably at least between 100 and 140 cm, more preferably at least between 100 and 130 cm, in particular without structurally comprising the door, e.g., due to buckling, creasing, etc.

Preferably, the slats are spaced apart from each other by a distance from 1 mm to 20 mm, more preferably 1.5 mm to 10 mm, more preferably 2 mm to 8 mm, more preferably 2 mm to 6 mm, more preferably 2 mm to 4 mm. The above-recited distance(s) refer to distance(s), i.e., spacing, between adjacent slats.

Preferably, the door includes a plurality of the at least one guide element. Preferably, the plurality of guide elements are spaced apart from each other. Preferably each guide element is connected to at least one of the slats, respectively.

Preferably, each of the guide elements is attached to one of the slats, respectively, and one or more of the slats are free of a guide element. Thus, the door may be configured such that not all of the slats are connected with a guide element. This may reduce the costs and/or the complexity and/or the weight of the door.

Preferably, a first guide element of the guide elements is attached to a first slat of the slats and a second guide element of the guide elements is attached to a second slat of the slats. Preferably, one or more slats arranged between the first slat and the second slat are free of a guide element. Preferably, every second slat of the plurality of slats, more preferably every third slat of the plurality of slats, more preferably every fourth slat of the plurality of slats, more preferably every fifth slat of the plurality of slats, is provided with a guide element, wherein the slats therebetween may be free of a guide element. Generally speaking, the door may be provided with guide elements with a smaller or no distance between adjacent guide elements, if the door is larger and/or heaver, and vice versa, if the door is smaller and/or lighter.

Alternatively, or additionally, the door may be provided with guide elements with a smaller distance between adjacent guide elements, if the door is to be more flexible, in particular more bendable, in particular with one or more smaller radii, and vice versa, if the door is to be less flexible, in particular less bendable, in particular with one or more larger radii. In particular, providing a smaller distance between adjacent guide elements, if the door is to be more flexible, in particular more bendable, in particular with one or more smaller radii, may provide a greater degree of guidance to the door which may facilitate opening and closing the door.

The door may also have variable distances between adjacent guide elements, depending on the desired characteristics of the respective sections of the door. For instance, if one or more first sections of the door is/are configured to remain substantially straight, or at least have great radii compared with one or more second sections of the door, the distance between adjacent guide elements may be larger, e.g., less guide elements may be employed, in the one or more first sections of the door than in one or more second sections which bend during opening/closing of the door and/or bend at smaller radii.

Preferably, the connecting layer includes one or more layers which include(s) one or more of the following: at least one layer of foam and/or at least one layer of fabric and/or a cloth, preferably a unidirectional cloth, a non-woven veil, and/or at least one layer of textile and/or at least one laminate layer and/or a material which includes synthetic and/or natural fibers, preferably linen fibers, cotton fibers, cellulose fibers, viscose fibers, acrylic fibers, polypropylene fibers, polyamide fibers and/or polyester fibers. The recited material(s) may provide a relatively light, flexible, and/or durable connecting layer.

Preferably, the connecting layer is made of one or more of the following materials: a foam and a laminate. Preferably the foam is made of one or more of the following materials: acrylate, polyurethane, polyvinylchloride (PVC), nitrile butadiene rubber (NBR), a blend of PVC and NBR.

Preferably, the connecting layer includes a foam, preferably an acrylic foam, preferably wherein the foam is a soft and/or flexible foam. Preferably, the foam material is based on one or more polyolefins, preferably at least one of polyethylene (PE), polypropylene (PP), an acrylate, polyurethane (PU), polyvinyl chloride (PVC), nitrile butadiene rubber (NBR), a blend of PVC and NBR, one or more polyester variants, nitrile butadiene rubber, and/or or any other thermoplastic foam. The foam may be a double-sided adhesive foam.

Preferably the foam used in any the embodiments of the present invention is configured to pass the vertical burn test, in particular when the decorative article is configured for use in aircrafts and/or watercrafts. The vertical burn test may be performed as defined by the U.S. Federal Aviation Administration (FAA) in the Code of Federal Regulations (CFR), more specifically in CFR Title 14, Subchapter C, Appendix F to Part 25, Part I (a)(1)(i) in connection with CFR Title 14, Subchapter C, Appendix F to Part 25, Part I (b)(4), also known as the 60 second vertical burn test. Additionally, or alternatively, the vertical burn test may be performed pursuant to CFR Title 14, Subchapter C, Appendix F to Part 25, Part I (a)(1)(ii) in connection with CFR Title 14, Subchapter C, Appendix F to Part 25, Part I (b)(4), also known as the 12 second vertical burn test. The version of the above-identified Code of Federal Regulations (CFR) which is in force as of May 20, 2022 is to be applied.

Preferably, the connecting layer includes at least one layer of soft and/or flexible foam and at least one laminate layer attached to at least one side of the foam which faces the exterior of the body, when the door is attached to the body.

Preferably, the foam has a density in a range between 0.5 g/cm3 and 2.5 g/cm3, preferably 0.5 g/cm3 and 2 g/cm3, more preferably 0,5 g/cm3 and 1.75 g/cm3, more preferably 0,5 g/cm3 and 1.5 g/cm3, more preferably 0.75 g/cm3 and 1.2 g/cm3.

The foam layer may

have a thickness of 0.1 mm - 8 mm, preferably 0.1 mm - 6 mm, preferably 0.2 mm - 4 mm, preferably 0.2 mm - 3 mm, preferably 0.2 mm - 2 mm, preferably 0.5 mm - 1.5 mm; and/or

have a 25% compression deflection force (in pounds per square inch, psi), preferably according to ASTM D1056, of 1 psi - 15 psi, preferably 1 psi - 10 psi, preferably 1 psi - 8 psi, preferably 2 psi - 7 psi, preferably 2 psi - 6 psi, preferably 3 psi - 6 psi; and/or

have a 50% compression set (in %), preferably according to ASTM D1056, of 1% - 20%, preferably 2% - 15%, preferably 2% - 12%, preferably 3% - 11%, preferably 3% - 10%; and/or

have a density (in pounds per cubic foot, PCF), preferably according to ASTM D1056, of 5 PCF - 15 PCF, preferably 6 PCF - 13 PCF, preferably 7 PCF - 12 PCF, preferably 8 PCF - 11 PCF; and/or

be made of one or more of the following materials, without being limited thereto: polyurethane, polyvinylchloride (PVC), nitrile butadiene rubber (NBR), a blend of PVC and NBR.

Preferably, the guide element(s) is/are arranged completely on the side of the slat(s) which faces the interior of the body, at least when the door is in a closed position. In particular, the guide element(s) may be arranged completely behind the slats, when viewing the door from the exterior of the body, when the door is in a closed position.

Preferably, a lateral edge of the slats and/or the connecting layer and/or the outer layer extends beyond the guide element(s), in an opening direction and/or a closing direction of the door. Alternatively, or additionally, a lateral edge of the slats and/or the connecting layer and/or the outer layer may extend beyond the guide element(s), in a direction which is substantially perpendicular to an opening direction and/or a closing direction of the door. This may further enhance the aesthetic properties of the door, e.g., by reducing visible seams and/or reducing the visibility of seams and/or by increasing an effect of hiding the guide element(s).

Preferably, a width of a connecting interface of each guide element, the connecting interface facing one or more of the slats, is no greater than a width of each slat. This may reduce or eliminate any negative effects the guide element(s) may have on the door, in particular the slats, in particular with respect to the flexibility and/or bendability of the door. The width of the interface and the slat may extend along an opening direction and/or a closing direction of the door and/or substantially perpendicularly to a longitudinal axis of the guide element and/or substantially perpendicularly to a longitudinal axis of the slat. The connecting interface serves the purpose of connecting the guide element to the slat(s), directly or indirectly. In other words, the connecting interface abuts the slat(s) or at least one intermediate structure between the slats and the guide elements. The connecting interface may include one or more surfaces.

The connecting interface may be configured as an end of the respective guide element, in particular a proximal end.

Each guide element may include at least one second interface, which may be configured as an end, in particular a distal end, of the respective guide element, which may be configured to interact with the counter guide element of the body.

The second interface may include at least one sliding surface configured to slide along at least one surface of the counter guide element of the body. The sliding surface may be provided on a cylindrical portion of the second interface. Alternatively, or additionally, the second interface may include at east one roller configured to roll on at least one surface of the counter guide element of the body.

The second interface may be configured to interact, e.g., be at least partially received by and/or engage with, at least one groove and/or rail of the counter guide element of the body.

The second interface may include at least one engagement member configured to engage with at least one groove and/or at least one track of the counter guide element of the body. The engagement member may be configured to slide, e.g., non-rotatably, and/or roll, e.g., via at least one roller, on the groove and/or track of the counter guide element of the body. The engagement member may have any shape and/or dimension(s). Preferably, the engagement member has a cylindrical cross-section. Preferably, the engagement member has at least one dimension which is no more than 1 mm, preferably 0.5 mm, more preferably 0.3 mm, smaller than a dimension of the groove and/or track in the same direction. For instance, the engagement member may have a substantially cylindrical shape with a diameter which is no more than 1 mm, preferably 0.5 mm, more preferably 0.3 mm, smaller than a dimension of the groove and/or track in the same direction. The diameter of the engagement member may be between 4 and 20 mm, preferably between 6 and 16 mm, preferably between 8 and 12 mm.

Preferably, the engagement member has a dimension, e.g., a diameter of the engagement member, which extends in the same direction as a width of the respective slat, which extends in an opening direction and/or a closing direction of the door and/or substantially perpendicularly to a longitudinal axis of the respective slat. The dimension of the engagement member may be up to 5 %, preferably up to 10 %, more preferably up to 20 %, more preferably up to 30 %, smaller than the width of the slat or, alternatively, the dimension of the engagement member may be substantially identical to the width of the slat or, alternatively, the dimension of the engagement member may be up to 5 %, preferably up to 10 %, more preferably up to 20 %, more preferably up to 30 % larger than the width of the slat. The larger the dimension of the engagement member the more support the engagement member may provide to the door. However, the smaller the dimension of the engagement member is, the smaller the radius/radii by which the door may be bent/curved, in particular during opening/closing the door. Hence, the door described herein may strike a balance between the achievable radius/radii and a degree of support provided by the engagement member(s).

Preferably, the guide element(s) extend(s) from the side of the slat(s) which faces the interior of the body towards and/or into the interior of the body, when the door is attached to the body. This may allow, e.g., to arrange the counter guide element further in the interior of the body.

Preferably, the door, preferably the guide elements, is/are configured such that a front surface of the door, which faces the exterior of the body, when the door is attached to the body, is substantially flush with one or more front surfaces of the body which face the exterior of the body. This may increase the aesthetic appeal of the door, more specifically of the combined body and door.

Preferably, each guide element includes at least one engagement member configured to engage with the counter guide element, preferably with at least one groove and/or at least one track of the counter guide element. Preferably, the engagement member is configured to slide and/or roll on at least one surface of the counter guide element, preferably on at least one surface of at least one groove and/or track of the counter guide element, while slidably opening and/or closing the door.

Preferably, at least some of the engagement members include at least one roller configured to roll, i.e., rotate, along the counter guide element of the body, when the door is slidably opened and/or closed. The door may be configured such that the roller may be locked to substantially prevent the roller from rolling, e.g., when it is desired to maintain the door in a certain position, e.g., in the closed position and/or open position. Additionally, or alternatively, the door may include other means, e.g., at least one stopper, for substantially maintaining the door in a certain position.

Preferably, the door may include a first plurality of the guide elements arranged along a top section of the door and a second plurality of the guide elements arranged along a bottom section of the door. The first plurality of the guide elements may be configured to cooperate, e.g., engage, with at least one first counter guide element of the body arranged along a top section of the body and the second plurality of the guide elements may be configured to cooperate, e.g., slidably and/or rotatably engage, with at least one second counter guide element of the body arranged along a bottom section of the body. In other words, the counter guide elements may extend substantially horizontally, when the door and the body are in an operational position. This may allow the door to be opening horizontally, i.e., laterally or sideways. Preferably, at least some of the first plurality of the guide elements include at least one roller configured to roll along at least one surface of the first counter guide element and the second plurality of the guide elements are configured to non-rotatably cooperate with the second counter guide element, e.g., by sliding along the second counter guide element. This may allow the rollers of the first plurality of the guide elements to carry most, or all, of the weight of the door via the rollers, while the second plurality of the guide elements carries less weight of the door. Instead, the second plurality of the guide elements may primarily guide the door between the closed position and the open position, rather than primarily carrying the weight of the door.

Preferably, the door is provided with a plurality of different guide elements, i.e., guide elements having different configurations. Preferably, a first type of the plurality of guide elements has at least one engagement member which includes at least one roller configured to roll, i.e., rotate, along the counter guide element of the body, when the door is slidably opened and/or closed. Preferably, a second type of the plurality of guide elements has at least one engagement member which includes at least one sliding surface configured to slide along at least one surface of the counter guide element of the body, when the door is slidably opened and/or closed. Preferably, the door includes one or more of the first type of the guide element and one or more of the second type of the guide element. The door may include more than two different types of guide elements. Each type of guide element may be arranged at one or more specific, i.e., predetermined, position on the door. Preferably, one of more of the first type of guide element may be arranged at an uppermost end of the door, if the door is configured to be opened vertically, whereas one or more the second type of guide element may be arranged therebelow. Surprisingly, such a configuration has shown to be relatively durable and to have a relatively long lifetime.

Preferably, each guide element includes at least two engagement members which are spaced from each other. Preferably, the engagement members extend at an angle between 60° and 120°, preferably 75° and 105°, preferably at an angle of substantially 90°, relative to each other.

Preferably, one or more of the guide elements may have at least one enlarged section, i.e., compared with adjacent section(s) of the guide elements. The enlarged section may be configured to cooperate with and/or be received in a groove and/or opening of the body and/or counter guide element. This may increase a guiding effect and/or a smoother opening and closing operation of the door. Preferably, one or more of the guide elements include at least one roller at a distal end of the respective guide element and the enlarged section is arranged proximally therefrom and/or between an attachment interface of the guide element, between the guide element and the respective slat, and the roller.

Preferably, one or more of the guide element(s) is/are configured such that a position of the engagement member(s) relative to the counter guide element is adjustable. This may allow the engagement between the engagement member and the counter guide element to be optimized and/or individually adjusted. For instance, the guide element(s) may have one or more slots, preferably one or more elongated slots, which are configured to receive at least one connection element, e.g., at least one screw, in a plurality of different positions, e.g., to adjust the position of the engagement member(s) relative to the counter guide element is adjustable.

Preferably, the outer layer continuously covers each of the slats.

Preferably, the outer layer is configured as a single continuous, preferably seamless, layer which covers each of the slats.

Preferably, the outer layer is made of a flexible bendable material, at least one of the following: wood, preferably a wooden veneer, plastic, a OLED panel, an electronic screen configured to display static or dynamic content – preferably an OLED, AMOLED or micro-LED-display, at least one leather, at least one synthetic leather preferably made from synthetic or plant-based raw materials, at least one textile, at least one composite material, at least one laminate, at least one metal, at least one fabric, at least one foil, preferably at least one plastic foil and/or at least one metallic foil, at least one stone, at least one cardboard, at least one paper, at least one fiber composite, preferably one carbon fiber or glass fiber or plant based fiber composite, and at least one color painting .

A flexible screen, preferably an OLED or AMOLED screen included in the outer layer preferably has a minimum bending radius of 15mm, more preferably of 6mm, more preferably of 4mm, most preferably of 1mm. Preferably the thickness of the display area (without housing) is 0,005 – 0,02mm.

For example the display can be a 3rd Generation Cicada wing Fully Flexible Display (Royole) or a Wisecoco 6 Inch Rollable IPS Flexible OLED 2880*1440 AMOLED Display Thin Screen.

Preferably, the outer layer is made of at least one wooden veneer and/or at least one laminate. The outer layer may be configured as or may include at least one wooden veneer which may include one or more veneer layers. The wooden veneer may include one or more layers of the following types of wood: maple, birch, beech, oak, alder, pine, cherry, mahogany, walnut, teak, or any combination thereof.

Each veneer layer may be treated with at least one flame retardant.

The outer layer may have a total thickness of 0.2 to 5 mm, preferably 0.3 to 2 mm.

The outer layer may have a thickness of 0.2 to 5 mm, preferably 0.3 to 2 mm, more preferably 0.4 to 1.2 mm, more preferably 0.4 to 0.8 mm. The outer layer may be made of or may include one or more of the following: polyolefins such as polyethylene, polyvinyl chloride, polystyrene (PS), various polyesters such as polyethylene terephthalate (PET), polycarbonate (PC), polyurethane, copolymers such as acrylonitrile butadiene styrene (ABS), bio-based plastics such as polylactide (PLA), cellulose acetate or starch blends, and combination or composite materials thereof. Alternatively, or additionally, the outer layer may be made of or may include one or more of the following one or more composite layers, such as ABS/PMMA films (e.g., senosan® films available from Senosan GmbH in Austria), PMMA/PVDF films, preferably ABS/PMMA films, in high-gloss, matte or embossed finish.

Alternatively, or additionally, the outer layer may include one or more antibacterial/antiviral media and/or one or more anti-fingerprint elements.

Preferably, the body is a body of at least one compartment, preferably at least one piece of furniture, preferably at least one cabinet, preferably at least one kitchen cabinet, preferably at least one office cabinet, preferably at least one cabinet of an aircraft and/or a watercraft.

Preferably, the door includes at least one flame retardant provided in one or more components of the door, preferably at least in the slats and/or the outer layer.

Preferably, a longitudinal axis of each of the slats extends in a direction which is at an angle to a closing direction and/or an opening direction of the door of at least 45°, preferably at least 55°, more preferably at least 65°, more preferably at least 75°, more preferably at least 85°, most preferably substantially 90°. The above-recited angle(s) may provide a balance between a relatively high degree of flexibility and a relatively high degree of rigidity of the door, in particular when opening and/or closing the door.

Preferably, the slats preferably each have a cross-sectional shape which is one of: rectangular, square, trapezoidal, and oval. Alternatively, the slats may have any cross-sectional shape.

Preferably, each slat has a width which extends substantially perpendicularly to a longitudinal axis of each slat and/or to a closing direction and/or an opening direction of the door, the width ranging from 4 mm to 20 mm, preferably from 5 mm to 18 mm, more preferably from 6 mm to 16 mm, more preferably from 6 mm to 10 mm. The above-recited value(s) may strike a balance between rigidity of the slats and flexibility of the door.

Preferably, each slat has a thickness which extends substantially perpendicularly to a width of each slat, the width extending substantially perpendicularly to a longitudinal axis of each slat and/or to a closing direction and/or an opening direction of the door. Preferably, the thickness ranges from 4 mm to 20 mm, preferably from 5 mm to 18 mm, more preferably from 6 mm to 16 mm.

Preferably, the slats are made of at least one of the following: wood, preferably plywood, preferably solid wood, at least one plastic, at least one foam, at least one metal, and at least one composite material.

Preferably, the slats are at least partially made of wood, preferably plywood, which has a density from 0.3 to 0.8 g/cm3, preferably from 0.35 to 0.7 g/cm3.

Preferably, the slats have a bending strength, with respective to a longitudinal axis of each slat, from 15 N/mm2 to 100 N/mm2, preferably from 15 N/mm2 to 90 N/mm2, more preferably from 15 N/mm2 to 80 N/mm2, more preferably from 15 N/mm2 to 70 N/mm2, more preferably from 15 N/mm2 to 60 N/mm2, more preferably from 20 N/mm2 to 60 N/mm2, more preferably from 20 N/mm2 to 50 N/mm2, more preferably from 25 N/mm2 to 45 N/mm2.

Preferably, the slats have a bending strength, with respective to a direction which is substantially perpendicular to a longitudinal axis of each of the slats, from 10 N/mm2 to 60 N/mm2, preferably from 10 N/mm2 to 50 N/mm2, more preferably from 15 N/mm2 to 50 N/mm2, more preferably from 15 N/mm2 to 45 N/mm2, more preferably from 20 N/mm2 to 45 N/mm2, more preferably from 25 N/mm2 to 45 N/mm2.

Preferably, the slats have a bending elastic modulus, with respective to a direction which is substantially perpendicular to a longitudinal axis of each slat, from 1000 N/mm2 to 10000 N/mm2, preferably from 1500 N/mm2 to 10000 N/mm2, more preferably from 2000 N/mm2 to 10000 N/mm2, more preferably from 2500 N/mm2 to 10000 N/mm2, more preferably from 3000 N/mm2 to 10000 N/mm2, more preferably from 3500 N/mm2 to 10000 N/mm2, more preferably from 3500 N/mm2 to 9000 N/mm2, more preferably from 4000 N/mm2 to 9000 N/mm2, more preferably from 4000 N/mm2 to 8000 N/mm2. The bending elastic modulus is also known as bending modulus or flexural modulus. Surprisingly, the inventors found that other ranges of values cause instability of the door during repeated opening and closing. Conversely, too high stiffness may lead to high stresses that may eventually damage the decorative top layer.

Preferably, each slat is made partially of wood, preferably plywood, and partially of at least one non-wooden material, preferably of at least one foam.

The foam of the slats may be a closed-cell structural foam, preferably a closed-cell thermoplastic structural foam which is recyclable. The foam may have a density between 0.5 g/cm3 and 2.5 g/cm3, preferably 0.5 g/cm3 and 2 g/cm3, more preferably 0,5 g/cm3 and 1.75 g/cm3, more preferably 0,5 g/cm3 and 1.5 g/cm3, more preferably 0.75 g/cm3 and 1.2 g/cm3. The flatwise E-module in the plane of the foam panel is preferably 50-175 N/mm², more preferably 70-110N/mm², most preferably 85-90 N/mm². The flatwise E-module for instance can by determined by ASTM C297. The tensile modulus measured perpendicular to the plane is preferably 100-250 MPa, more preferably 150-200MPa. The tensile modulus for instance can be determined by ASTM D1623.

The flatwise tensile strength of the foam panel is preferably 1-3 N/mm², more preferably 1.3-2.5N/mm². The flatwise tensile strength for instance can by determined by ASTM C297. The tensile strength measured perpendicular to the plane is preferably 2-40 MPa, more preferably 2-20MPa, more preferably 2-6 MPa, most preferably 3-5.5 MPa. The tensile strength for instance can be determined by ASTM D1623.

The compressive strength of the foam perpendicular to the plane is preferably 0.5-50MPa, more preferably 0.5-40 MPa, more preferably 0.5-4 N/mm², more preferably 0.7-3N/mm². The compressive strength for instance can by determined by ISO 844:2021 or by ASTM D1621. Surprisingly using foam with the properties described herein results in doors which are solid while retaining enough flexibility to bend and to pass the mentioned life-cycle requirements

The proportion of the mass of the foam relative the total mass of each slat, depending on the dimensions and density of the materials of the slat, is approximately 30% to 90%.

Each slat may have a total density of less than 0.8 g/cm3, preferably less than 0,4 g/cm3, more preferably less than 0.25 g/cm3.

Preferably, each slat includes at least two ends, which are preferably made of wood, preferably plywood, plastic, metal, or the like, and at least one intermediate section which interconnects the ends. The intermediate section may be made at least partially of a non-wooden material, preferably of at least one foam. Surprisingly, the inventors found that slats made partially of foam with ends of plywood, optionally with a laminate, have sufficient strength and wear resistance for use. At the same time, the foam, especially in the case of a relatively thin connecting layer and outer layer, may help the viewing side of the door to appear relatively smooth and may prevent the individual slats from being visible due to visible parallel lines in the outer layer.

Preferably, each slat may include plywood combined with one or more laminates and synthetic foam. For example, each slat may include plywood at each end of the respective slat, e.g., having a length of 7 to 8 cm, e.g., for fastening the guide elements, a synthetic foam in between the plywood ends to save weight, and a laminate layer extending over the plywood and synthetic foam for sufficient strength.

Preferably, each slat may include a laminate structure with plywood outer layers combined with plastic foam. For example, each slat may have 2 layers of plywood, for strength and for attaching the guide elements, each preferably with a thickness of 1.0 to 6.0 mm, preferably about 3 mm, and a synthetic foam arranged in between, e.g., to save weight, the foam having a thickness of about 1 to 18 mm, preferably 5 to 12 mm, along the width of the respective slat.

Preferably, the ends are made of a material which has a greater density than a material which the intermediate section is made of.

Preferably, each slat is at least partially made of a composite material which includes at least one core and at least one cover layer or outer layer which at least partially covers the core. Preferably, the core is made of a material which has a density which is lower than a density of a material which the cover layer is made of. Preferably, the core is at least partially made of at least one foam. Preferably, the outer layer is at least partially made of wood, preferably plywood, and/or a laminate, preferably a high pressure laminate and/or a continuous pressed laminate. The laminate may be a high-pressure laminate (HPL) or a continuous pressed laminate (CPL), which may be include one or more decorative papers, one or more kraft papers and/or one or more aramid papers and/or one or more resins, etc. Preferably the laminate is B1 quality.

More preferably the outer layer contains reinforcement fibers. Reinforcement fibers can be made from synthetic or natural organic polymers – e.g. viscose, PP-fibers, aramid-fibers – or inorganic fibers – e.g. glass fibers or carbon fibers. Fibers may be arranged in a non-woven form or preferably in one or more woven sheets. Preferably a glue or resin, preferably a thermoplastic resin, more preferably a thermoset resin. Preferably the thermoset resin contains a melamine resin, a phenolic resin, a phenolic-formaldehyde resin, a formaldehyde containing resin or a furfural resin. Most preferably the resin also contains a flame retardant, most preferably a phosphorous-nitrogen flame retardant. Most preferably the cover layer contains or is made from a pre-preg, most preferably an aircraft pre-preg.

Preferably, the door is configured to be bent, while closing and/or opening the door. The door may be configured to be bent, while closing and/or opening the door, concavely and/or convexly, with respect to a direction from the interior of the body to the exterior of the body.

In such a bent configuration an angle is formed between at least two adjacent sections of the door. The angle formed between the at least two adjacent sections of the door are preferably no more than 170°, preferably no more than 160°, more preferably no more than 150°, more preferably no more than 140°, more preferably no more than 130°, more preferably no more than 120°, more preferably no more than 110°, more preferably no more than 100°, more preferably no more than 90°.

Preferably, the door is configured to be bent, while closing and/or opening the door, such that at least one section of the door forms a radius of at least 50 mm, preferably of at least 60 mm, more preferably of at least 70 mm, more preferably of at least 80 mm, more preferably of at least 90 mm, more preferably of at least 100 mm, more preferably of at least 120 mm, without structurally compromising the door, e.g., for at least 100.000 cycles of opening and closing. The radius is determined based on an inner surface of the innermost layer of the door, excluding the slats and the guide elements, which faces the interior of the body, when the door is mounted to the body.

Preferably, the door is configured to be bent, while closing and/or opening the door. Depending on the size of the door, the material and dimensions of the slats, the material and thickness of the connecting layer and the material and thickness of the outer layer at least one section of the door can form a smaller radius, for example a radius from 30 mm to 120 mm, preferably from 40 mm to 110 mm, more preferably from 40 mm to 100 mm, more preferably from 40 mm to 90 mm, more preferably from 40 mm to 80 mm, more preferably from 40 mm to 70 mm, more preferably from 40 mm to 60 mm. The radius is determined based on an inner surface of the innermost layer of the door, excluding the slats and the guide elements, which faces the interior of the body, when the door is mounted to the body.

Preferably, the outer layer is at least partially covered by at least one coating selected from one or more of the following: at least one color coating, at least one clear coating, at least one oil, preferably linseed oil and/or soybean oil, at least one acrylic coating, at least one polyurethane coating.

Preferably, the connecting layer has a thickness, which extends between the first side and the second side, from 0.5 mm to 5 mm, preferably from 0.5 mm to 4.5 mm, more preferably from 0.5 mm to 4 mm, more preferably from 0.5 mm to 3.5 mm, more preferably from 0.5 mm to 3 mm, more preferably from 0.5 mm to 2.5 mm, more preferably from 0.5 mm to 2 mm, more preferably from 1 mm to 1.8 mm.

Preferably, the connecting layer has a total density of 0.5 g/cm3 to 4 g/cm3, preferably 1 g/cm3 to 3.5 g/cm3, more preferably 1 g/cm3 to 3 g/cm3, more preferably 1 g/cm3 to 2.5 g/cm3, more preferably 1 g/cm3 to 2 g/cm3 auf, more preferably 1 g/cm3 to 1.8 g/cm3, more preferably 1 g/cm3 to 1.6 g/cm3, more preferably 1 g/cm3 to 1.4 g/cm3.

The present disclosure also relates to a compartment which includes at least one body and at least one opening defined in the body. The compartment may further include at least one door according to any of the embodiments described herein which is slidably attached to the body to slidably open and close the opening. The features, configurations and/or advantages described above in relation to the door also apply to the compartment accordingly.

Preferably, in case of a side-wise opening door, a bottom panel of the body includes at least one of the at least one counter guide element, preferably along a surface of the bottom panel which faces away from the interior of the body. Preferably, a top panel of the body also includes at least one of the at least one counter guide element, preferably along a surface of the top panel which faces towards the interior of the body.

The object set out at the beginning is also solved by a method for manufacturing a door configured to be slidably attached to a body to slidably open and close at least one opening defined in the body. The features, configurations and/or advantages described above in relation to the door also apply to the method accordingly.

The method may include: attaching a plurality of slats to a first side of a connecting layer which is at least partially flexible, wherein the first side faces an interior of the body, when the door is attached to the body.

The method may include: attaching at least one outer layer, which is at least partially flexible, to a second side of the connecting layer, wherein the second side is substantially opposite from the first side and faces an exterior of the body, when the door is attached to the body.

The method may include: attaching at least one guide element to an inner side of at least one of the slats, the inner side facing the interior of the body, when the door is attached to the body. The guide element may be configured to cooperate with at least one counter guide element of the body to guide the door, when the door is slidably opened and/or closed.

Preferably, the method includes: providing a frame, preferably made of wood, preferably plywood, the frame having an opening defined therein; arranging at least one insert made of at least one solid material, preferably a foam material, within the opening of the frame; attaching the connecting layer, and optionally also the outer layer, to the frame and the insert to interconnect the frame and the insert; and removing sections of the frame and the insert such that the remaining sections of the frame and the insert form the slats which are interconnected by the connecting layer.

The opening may be a through-opening.

Preferably, removing sections of the frame and the insert such that the remaining sections of the frame and the insert form the slats which are interconnected by the connecting layer includes cutting, preferably milling, the sections of the frame and the insert which are to be removed.

Preferably, the method further includes: providing at least one core, preferably wherein the core is made of at least one foam; providing at least one cover layer, which preferably has a density which is greater than a density of a material of the core, preferably wherein the cover layer is at least partially made of wood, preferably plywood; attaching the cover layer to the core, preferably by sandwiching the core between two layers of the cover layer; attaching the connecting layer, and optionally also the outer layer, to the cover layer; and removing sections of the core and the cover layer(s) such that the remaining sections of the core and the cover layer(s) form the slats which are interconnected by the connecting layer.

Preferably, removing sections of the core and the cover layer(s) such that the remaining sections of the core and the cover layer(s) form the slats which are interconnected by the connecting layer includes cutting, preferably milling, the sections of the core and the cover layer(s) which are to be removed.

The object set out at the beginning is also solved by a method for manufacturing a plurality of slats of a door configured to be slidably attached to a body to slidably open and close at least one opening defined in the body. The features, configurations and/or advantages described above in relation to the door also apply to the method accordingly.

The method may include: providing a frame, preferably made of wood, preferably plywood, the frame having an opening defined therein.

The method may include: arranging at least one insert made of at least one solid material, preferably a foam material, within the opening of the frame.

The method may include: attaching the connecting layer, and optionally also the outer layer, to the frame and the insert to interconnect the frame and the insert.

The method may include: removing sections of the frame and the insert such that the remaining sections of the frame and the insert form the slats which are interconnected by the connecting layer.

The object set out at the beginning is also solved by a method for manufacturing a plurality of slats of a door configured to be slidably attached to a body to slidably open and close at least one opening defined in the body.

The method may include: providing at least one core, preferably wherein the core is made of at least one foam.

The method may include: providing at least one cover layer which has a density which is greater than a density of a material of the core, preferably wherein the cover layer is at least partially made of wood, preferably plywood.

The method may include: attaching the cover layer to the core, preferably by sandwiching the core between two layers of the cover layer.

The method may include: attaching the connecting layer, and optionally also the outer layer, to the cover layer.

The method may include: removing sections of the core and the cover layer(s) such that the remaining sections of the core and the cover layer(s) form the slats which are interconnected by the connecting layer.

Additional material may be added to the slats after forming the slats, e.g., one or more coatings.

### The following list of aspects provides alternative and/or further features of the invention

1. A door configured to be attached, preferably slidably attached, to at least one body to open and close, preferably slidably, at least one opening defined in the body, the door including:

a plurality of slats;

at least one connecting layer which is at least partially flexible and has a first side, which faces an interior of the body, and a second side, which faces an exterior of the body, when the door is attached to the body, the first side preferably being substantially opposite from the second side, wherein the slats are fixedly attached to the first side of the connecting layer;

at least one outer layer which is at least partially flexible, wherein the outer layer is fixedly attached to the second side of the connecting layer; and

at least one guide element which is arranged at least partially on a side of the slat(s) which faces the interior of the body, when the door is attached to the body, the guide element being configured to cooperate with at least one counter guide element of the body to guide the door, when the door is slidably opened and/or closed, preferably wherein the guide element(s) is/are connected to at least one of the slats.

2. The door according to aspect 1, wherein an inner side of each slat which faces the interior of the body is free of any interconnection to at least one adjacent slat.

3. The door according to aspect 1 or 2, wherein the door is configured to slidably open and close at least one opening in the body which has an area of at least 600 cm2, preferably at least 1000 cm2, more preferably at least 1400 cm2, more preferably at least 1800 cm2, more preferably at least 2200 cm2, more preferably at least 2600 cm2, more preferably at least 3000 cm2, more preferably at least 3400 cm2, more preferably at least 3800 cm2, more preferably at least 4200 cm2, more preferably at least 4600 cm2, more preferably at least 5000 cm2, more preferably at least 5400 cm2, more preferably at least 5800 cm2, more preferably at least 6200 cm2, more preferably at least 6700 cm2, more preferably at least 7200 cm2, more preferably at least 7600 cm2, more preferably at least 8000 cm2, more preferably at least 8500 cm2, more preferably at least 9000 cm2, more preferably at least 9500 cm2.

4. The door according to any of the preceding aspects, wherein the door is configured to slidably open and close at least one opening in the body which has a width, which extends in a direction which is substantially perpendicular to a closing direction and/or an opening direction of the door, between 10 and 150 cm, preferably between 20 and 140 cm, more preferably between 30 and 130 cm, more preferably between 40 and 130 cm, more preferably between 50 and 120 cm, more preferably between 60 and 110 cm, more preferably between 59 and 100 cm.

5. The door according to any of the preceding aspects, wherein the door is configured to slidably open and close at least one opening in the body which has a length, which extends in a direction along a closing direction and/or an opening direction of the door, of at least between 30 and 250 cm, preferably at least between 40 and 230 cm, more preferably at least between 50 and 220 cm, more preferably at least between 60 and 210 cm, more preferably at least between 70 and 200 cm, more preferably at least between 80 and 190 cm, more preferably at least 90 and 180 cm, more preferably at least between 90 and 180 cm, more preferably at least between 90 and 160 cm, more preferably at least between 100 and 150 cm, more preferably at least between 100 and 140 cm, more preferably at least between 100 and 130 cm.

6. The door according to any of the preceding aspects, wherein the slats are spaced apart from each other by a distance from 1 mm to 20 mm, more preferably from 1.5 mm to 10 mm, more preferably from 2 mm to 8 mm, more preferably from 2 mm to 6 mm, more preferably from 2 mm to 4 mm.

7. The door according to any of the preceding aspects, including a plurality of the at least one guide element, the plurality of guide elements being spaced apart from each other.

8. The door according to aspect 7, wherein each of the guide elements is attached to one of the slats, respectively, and one or more of the slats are free of a guide element.

9. The door according to aspect 7 or 8, wherein a first guide element of the guide elements is attached to a first slat of the slats and a second guide element of the guide elements is attached to a second slat of the slats, preferably wherein one or more slats arranged between the first slat and the second slat are free of a guide element.

10. The door according to any of the preceding aspects, wherein the connecting layer includes one or more layers which include(s) one or more of the following: at least one layer of foam and/or at least one layer of fabric and/or a cloth, preferably a unidirectional cloth, a non-woven veil, and/or at least one layer of textile and/or at least one laminate layer and/or a material which includes synthetic and/or natural fibers, preferably linen fibers, cotton fibers, cellulose fibers, viscose fibers, acrylic fibers, polypropylene fibers, polyamide fibers and/or polyester fibers.

11. The door according to any of the preceding aspects, wherein the connecting layer is made of one or more of the following materials, which are preferably arranged in layers: a foam, preferably an acrylic foam, and a laminate.

12. The door according to any of the preceding aspects, wherein the connecting layer includes a foam, preferably an acrylic foam, preferably wherein the foam is a soft and/or flexible foam, preferably wherein the foam material is based on one or more polyolefins, preferably at least one of polyethylene (PE), polypropylene (PP), an acrylate, polyurethane (PU), polyvinyl chloride (PVC), nitrile butadiene rubber (NBR), a blend of PVC and NBR, one or more polyester variants, nitrile butadiene rubber, and/or or any other thermoplastic foam, preferably wherein the foam is a double-sided adhesive foam.

13. The door according to any of the preceding aspects, wherein the connecting layer includes at least one layer of foam, which is soft and/or flexible, and at least one laminate layer attached to at least one side of the foam which faces the exterior of the body, when the door is attached to the body.

14. The door according to any of aspects 10 to 13, wherein the foam has a density in a range between 0.5 g/cm3 and 2.5 g/cm3, preferably 0.75 g/cm3 and 2 g/cm3, more preferably 1 g/cm3 and 2 g/cm3, more preferably 1 g/cm3 and 1.75 g/cm3, more preferably 1 g/cm3 and 1.5 g/cm3, more preferably 0.75 g/cm3 and 1.2 g/cm3.

15. The door according to any of the preceding aspects, wherein the guide element(s) is/are arranged completely on the side of the slat(s) which faces the interior of the body, at least when the door is in a closed position.

16. The door according to any of the preceding aspects, wherein:

a lateral edge of the slats and/or the connecting layer and/or the outer layer extends beyond the guide element(s), in an opening direction and/or a closing direction of the door;

and/or

a lateral edge of the slats and/or the connecting layer and/or the outer layer extends beyond the guide element(s), in a direction which is substantially perpendicular to an opening direction and/or a closing direction of the door.

17. The door according to any of the preceding aspects, wherein a width of a connecting interface of each guide element, the connecting interface facing one or more of the slats, is no greater than a width of each slat, wherein the width of the interface and the slat extends along an opening direction and/or a closing direction of the door and/or substantially perpendicularly to a longitudinal axis of the guide element and/or substantially perpendicularly to a longitudinal axis of the slat.

18. The door according to any of the preceding aspects, wherein the guide element(s) extend(s) from the side of the slat(s) which faces the interior of the body towards and/or into the interior of the body, when the door is attached to the body.

19. The door according to any of the preceding aspects, wherein the door, preferably the guide elements, is/are configured such that a front surface of the door, which faces the exterior of the body, when the door is attached to the body, is substantially flush with one or more front surfaces of the body which face the exterior of the body.

20. The door according to any of the preceding aspects, wherein each guide element includes at least one engagement member configured to engage with the counter guide element, preferably with at least one groove and/or at least one track of the counter guide element, preferably wherein the engagement member is configured to slide and/or roll on at least one surface of the counter guide element, preferably on at least one surface of at least one groove and/or track of the counter guide element, while opening and/or closing the door.

21. The door according to aspect 20, wherein at least some of the engagement members include at least one roller configured to roll along the counter guide element of the body, when the door is slidably opened and/or closed.

22. The door according to aspect 20 or 21, wherein each guide element includes at least two engagement members which are spaced from each other, preferably wherein the engagement members extend at an angle between 60° and 120°, preferably 75° and 105°, preferably at an angle of substantially 90°, relative to each other.

23. The door according to any of aspects 20 to 22, wherein one or more of the guide element(s) is/are configured such that a position of the engagement member(s) relative to the counter guide element is adjustable.

24. The door according to any of the preceding aspects, wherein the outer layer continuously covers each of the slats.

25. The door according to any of the preceding aspects, wherein the outer layer is configured as a single continuous, preferably seamless, layer which covers each of the slats.

26. The door according to any of the preceding aspects, wherein the outer layer is made of at least one of the following: wood, preferably a wooden veneer, plastic, one or more fibers, preferably one or more plant-based fibers, at least one leather, at least one synthetic leather, at least one textile, at least one composite material, at least one laminate, at least one metal, at least one fabric, at least one foil, preferably at least one plastic foil and/or at least one metallic foil, at least one stone, at least one cardboard, at least one paper, at least one fiber composite, preferably one carbon fiber or glass fiber or plant based fiber composite, and at least one color painting .

27. The door according to any of the preceding aspects, wherein the body is a body of at least one compartment, preferably at least one piece of furniture, preferably at least one cabinet, preferably at least one kitchen cabinet, preferably at least one office cabinet, preferably at least one cabinet of an aircraft and/or a watercraft.

28. The door according to any of the preceding aspects, wherein the door includes at least one flame retardant provided in one or more components of the door, preferably at least in the slats and/or the outer layer.

29. The door according to any of the preceding aspects, wherein a longitudinal axis of each of the slats extends in a direction which is at an angle to a closing direction and/or an opening direction of the door of at least 45°, preferably at least 55°, more preferably at least 65°, more preferably at least 75°, more preferably at least 85°, most preferably substantially 90°.

30. The door according to any of the preceding aspects, wherein the slats preferably each have a cross-sectional shape which is one of: rectangular, square, trapezoidal, and oval.

31. The door according to any of the preceding aspects, wherein each slat has a width which extends substantially perpendicularly to a longitudinal axis of each slat and/or to a closing direction and/or an opening direction of the door, the width ranging from 4 mm to 20 mm, preferably from 5 mm to 18 mm, more preferably from 6 mm to 16 mm, more preferably from 6 mm to 10 mm.

32. The door according to any of the preceding aspects, wherein each slat has a thickness which extends substantially perpendicularly to a width of each slat, the width extending substantially perpendicularly to a longitudinal axis of each slat and/or to a closing direction and/or an opening direction of the door, wherein the thickness ranges from 4 mm to 20 mm, preferably from 5 mm to 18 mm, more preferably from 6 mm to 16 mm.

33. The door according to any of the preceding aspects, wherein the slats are made of at least one of the following: wood, preferably plywood, preferably solid wood, at least one plastic, at least one metal, and at least one composite material.

34. The door according to any of the preceding aspects, wherein the slats are at least partially made of wood, preferably plywood, which has a density from 0.3 to 0.8 g/cm3, preferably from 0.35 to 0.7 g/cm3.

35. The door according to any of the preceding aspects, wherein the slats have a bending strength, with respective to a longitudinal axis of each slat, from 15 N/mm2 to 100 N/mm2, preferably from 15 N/mm2 to 90 N/mm2, more preferably from 15 N/mm2 to 80 N/mm2, more preferably from 15 N/mm2 to 70 N/mm2, more preferably from 15 N/mm2 to 60 N/mm2, more preferably from 20 N/mm2 to 60 N/mm2, more preferably from 20 N/mm2 to 50 N/mm2, more preferably from 25 N/mm2 to 45 N/mm2.

36. The door according to any of the preceding aspects, wherein the slats have a bending strength, with respective to a direction which is substantially perpendicular to a longitudinal axis of each of the slats, from 10 N/mm2 to 60 N/mm2, preferably from 10 N/mm2 to 50 N/mm2, more preferably from 15 N/mm2 to 50 N/mm2, more preferably from 15 N/mm2 to 45 /N/mm2, more preferably from 20 N/mm2 to 45 N/mm2, more preferably from 25 N/mm2 to 45 N/mm2.

37. The door according to any of the preceding aspects, wherein the slats have a bending elastic modulus, with respective to a direction which is substantially perpendicular to a longitudinal axis of each slat, from 1000 N/mm2 to 10000 N/mm2, preferably from 1500 N/mm2 to 10000 N/mm2, more preferably from 2000 N/mm2 to 10000 N/mm2, more preferably from 2500 N/mm2 to 10000 N/mm2, more preferably from 3000 N/mm2 to 10000 N/mm2, more preferably from 3500 N/mm2 to 10000 N/mm2, more preferably from 3500 N/mm2 to 9000 N/mm2, more preferably from 4000 N/mm2 to 9000 N/mm2, more preferably from 4000 N/mm2 to 8000 N/mm2.

38. The door according to any of the preceding aspects, wherein each slat is made partially of wood, preferably plywood, and partially of at least one non-wooden material, preferably of at least one foam.

39. The door according to any of the preceding aspects, wherein each slat includes at least two ends, which are preferably made of wood, preferably plywood, and at least one intermediate section which interconnects the ends, preferably wherein the intermediate section is made at least partially of a non-wooden material, preferably of at least one foam.

40. The door according to aspect 39, wherein the ends are made of a material which has a greater density than a material which the intermediate section is made of.

41. The door according to any of the preceding aspects, wherein each slat is at least partially made of a composite material which includes at least one core and at least one cover layer which at least partially covers the core, wherein the core is made of a material which has a density which is lower than a density of a material which the cover layer is made of, preferably wherein the core is at least partially made of at least one foam and the outer layer is at least partially made of wood, preferably plywood, and/or a laminate, preferably a high pressure laminate and/or a continuous pressed laminate and/or a metal, preferably aluminum and/or one fiber based composite, preferably one glass fiber or carbon fiber or plant fiber based composite.

42. The door according to any of the preceding aspects, wherein the door is configured to be bent, while closing and/or opening the door, such that an angle is formed between at least two adjacent sections of the door, the angle being no more than 170°, preferably no more than 160°, more preferably no more than 150°, more preferably no more than 140°, more preferably no more than 130°, more preferably no more than 120°, more preferably no more than 110°, more preferably no more than 100°, more preferably no more than 90°.

43. The door according to any of the preceding aspects, wherein the door is configured to be bent, while closing and/or opening the door, such that at least one section of the door forms a radius of at least 50 mm, preferably of at least 60 mm, more preferably of at least 70 mm, more preferably of at least 80 mm, more preferably of at least 90 mm, more preferably of at least 100 mm, more preferably of at least 120 mm .

44. The door according to any of the preceding aspects, wherein the door is configured to be bent, while closing and/or opening the door, such that at least one section of the door forms a radius from 30 mm to 120 mm, preferably from 40 mm to 110 mm, more preferably from 40 mm to 100 mm, more preferably from 40 mm to 90 mm, more preferably from 40 mm to 80 mm, more preferably from 40 mm to 70 mm, more preferably from 40 mm to 60 mm.

45. The door according to any of the preceding aspects, wherein the outer layer is at least partially covered by at least one coating selected from one or more of the following: at least one color coating, at least one clear coating, at least one oil, preferably linseed oil and/or soybean oil, at least one acrylic coating, at least one polyurethane coating.

46. The door according to any of the preceding aspects, wherein the connecting layer has a thickness, which extends between the first side and the second side, from 0.5 mm to 5 mm, preferably from 0.5 mm to 4.5 mm, more preferably from 0.5 mm to 4 mm, more preferably from 0.5 mm to 3.5 mm, more preferably from 0.5 mm to 3 mm, more preferably from 0.5 mm to 2.5 mm, more preferably from 0.5 mm to 2 mm, more preferably from 1 mm to 1.8 mm.

47. The door according to any of the preceding aspects, wherein the connecting layer has a total density of 0.5 g/cm3 to 4 g/cm3, preferably 1 g/cm3 to 3.5 g/cm3, more preferably 1 g/cm3 to 3 g/cm3, more preferably 1 g/cm3 to 2.5 g/cm3, more preferably 1 g/cm3 to 2 g/cm3 auf, more preferably 1 g/cm3 to 1.8 g/cm3, more preferably 1 g/cm3 to 1.6 g/cm3, more preferably 1 g/cm3 to 1.4 g/cm3.

48. A compartment which includes at least one body and at least one opening defined in the body, the compartment further including at least one door according to any of the preceding aspects which is slidably attached to the body to slidably open and close the opening.

49. The compartment according to aspect 48, wherein a bottom panel of the body includes at least one of the at least one counter guide element, preferably along a surface of the bottom panel which faces away from the interior of the body, preferably wherein a top panel of the body also includes at least one of the at least one counter guide element, preferably along a surface of the top panel which faces towards the interior of the body.

50. A method for manufacturing a door configured to be slidably attached to a body to slidably open and close at least one opening defined in the body, the method including:

attaching a plurality of slats to a first side of a connecting layer which is at least partially flexible, wherein the first side faces an interior of the body, when the door is attached to the body;

attaching at least one outer layer, which is at least partially flexible, to a second side of the connecting layer, wherein the second side is substantially opposite from the first side and faces an exterior of the body, when the door is attached to the body; and

attaching at least one guide element to an inner side of at least one of the slats, the inner side facing the interior of the body, when the door is attached to the body, the guide element being configured to cooperate with at least one counter guide element of the body to guide the door, when the door is slidably opened and/or closed.

51. The method according to aspect 50, further including:

providing a frame, preferably made of wood, preferably plywood, the frame having an opening defined therein;

arranging at least one insert made of at least one solid material, preferably a foam material, within the opening of the frame;

attaching the connecting layer, and optionally also the outer layer, to the frame and the insert to interconnect the frame and the insert;

removing sections of the frame and the insert such that the remaining sections of the frame and the insert form the slats which are interconnected by the connecting layer.

52. The method according to aspect 51, wherein removing sections of the frame and the insert such that the remaining sections of the frame and the insert form the slats which are interconnected by the connecting layer includes cutting, preferably milling, the sections of the frame and the insert which are to be removed.

53. The method according to any of aspects 50 to 52, further including:

providing at least one core, preferably wherein the core is made of at least one foam;

providing at least one cover layer, which preferably has a density which is greater than a density of a material of the core, preferably wherein the cover layer is at least partially made of wood, preferably plywood;

attaching the cover layer to the core, preferably by sandwiching the core between two layers of the cover layer;

attaching the connecting layer, and optionally also the outer layer, to the cover layer;

removing sections of the core and the cover layer(s) such that the remaining sections of the core and the cover layer(s) form the slats which are interconnected by the connecting layer.

54. The method according to aspect 53, wherein removing sections of the core and the cover layer(s) such that the remaining sections of the core and the cover layer(s) form the slats which are interconnected by the connecting layer includes cutting, preferably milling, the sections of the core and the cover layer(s) which are to be removed.

55. A method for manufacturing a plurality of slats of a door configured to be slidably attached to a body to slidably open and close at least one opening defined in the body, the method including:

providing a frame, preferably made of wood, preferably plywood, the frame having an opening defined therein;

arranging at least one insert made of at least one solid material, preferably a foam material, within the opening of the frame;

attaching the connecting layer, and optionally also the outer layer, to the frame and the insert to interconnect the frame and the insert;

removing sections of the frame and the insert such that the remaining sections of the frame and the insert form the slats which are interconnected by the connecting layer.

56. A method for manufacturing a plurality of slats of a door configured to be slidably attached to a body to slidably open and close at least one opening defined in the body, the method including:

providing at least one core, preferably wherein the core is made of at least one foam;

providing at least one cover layer which has a density which is greater than a density of a material of the core, preferably wherein the cover layer is at least partially made of wood, preferably plywood or metal, preferably aluminum;

attaching the cover layer to the core, preferably by sandwiching the core between two layers of the cover layer;

attaching the connecting layer, and optionally also the outer layer, to the cover layer;

removing sections of the core and the cover layer(s) such that the remaining sections of the core and the cover layer(s) form the slats which are interconnected by the connecting layer.

### BRIEF DESCRIPTION OF THE DRAWINGS

FIG. 1 shows, in a schematic side view, a door according to an embodiment of the present disclosure;

FIG. 2 shows, in a schematic view, a configuration of one or more guide elements of a door according to an embodiment of the present disclosure;

FIG. 3A shows, in a schematic view, a configuration of a guide element of a door according to an embodiment of the present disclosure;

FIG. 3B shows, in a schematic view, a configuration of a guide element of a door according to an embodiment of the present disclosure;

FIG. 4 shows, in a schematic and perspective view, a configuration of a guide element of a door according to an embodiment of the present disclosure;

FIG. 5 shows, in a schematic view, a configuration of a plurality of guide elements of a door according to an embodiment of the present disclosure;

FIG. 6 shows, in a schematic view, a door of a compartment according to an embodiment of the present disclosure;

FIG. 7 shows, in a schematic and perspective view, a first counter guide element of the compartment of FIG. 6;

FIG. 8 shows, in a schematic and perspective view, a second counter guide element of the compartment of FIG. 6;

FIG. 9 shows, in a schematic and perspective view, a door according to an embodiment of the present disclosure;

FIG. 10A shows, in a schematic and perspective view, a compartment according to an embodiment of the present disclosure in a closed state;

FIG. 10B shows, in a schematic and perspective view, the compartment of FIG. 10A in an open state;

FIG. 11A shows, in a schematic top view, the compartment of FIG. 10A;

FIG. 11B shows, in a schematic top view, the compartment of FIG. 10B.

### DETAILED DESCRIPTION

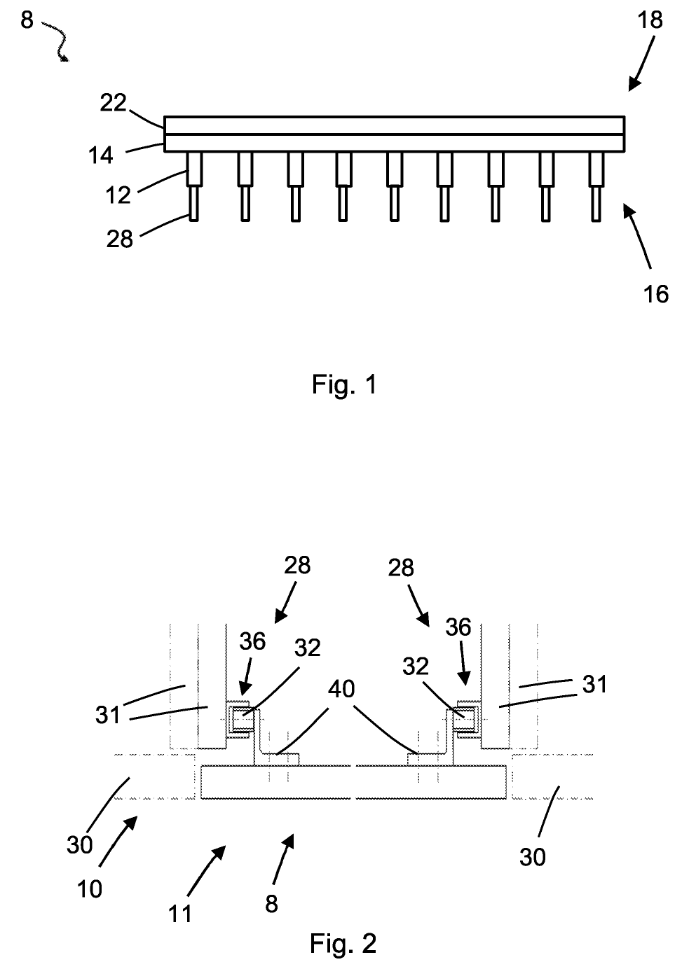

FIG. 1 show a door 8 configured to be slidably attached to a body 10 to slidably open and close at least one opening 11 defined in the body 10 (see, e.g., FIG. 2). The door 8 may include a plurality of slats 12. The door 8 may include at least one connecting layer 14 which is at least partially flexible and has a first side 16, which faces an interior of the body 10, and a second side 18, which faces an exterior of the body 10, when the door 8 is attached to the body 10. The first side 16 may be substantially opposite from the second side 18. The slats 12 may be fixedly attached, directly or indirectly, to the first side 16 of the connecting layer 14.

The door 8 may include at least one outer layer 22 which is at least partially flexible. The outer layer 22 may be fixedly attached, directly or indirectly, to the second side 18 of the connecting layer 14.

The door 8 may include at least one guide element 28 which may be connected to at least one of the slats 12, directly or indirectly, and may be arranged at least partially on a side of the slat(s) 12 which faces the interior of the body, when the door 8 is attached to the body. Each guide element 28 may be configured to cooperate with at least one counter guide element of the body to guide the door 8, when the door 8 is slidably opened and/or closed. FIG. 1 shows, in an exemplary manner, a plurality of guide elements 28. However, not all of the guide elements 28 are provided with a reference sign in FIG. 1 for the sake of ease.

One or more layers may be arranged between the connecting layer 14 and the slats 12 and/or one or more layers may be arranged between the connecting layer 14 and the outer layer 22. Alternatively, or additionally, one or more layers may be arranged between the slats 12 and the guide elements 28. Alternatively, or additionally, one or more layers, e.g., one or more coatings, may be arranged on the outer layer 22, i.e., towards the exterior or viewing side of the door 8, i.e., on a side of the outer layer 22 which is opposite from the connecting layer 14.

FIG. 2 shows a configuration of the guide elements 28. As shown in FIG. 2, the body 11 may include one or more front panels 30 and/or one or more side panels 31. Each guide element 28 may have at least one engagement member 32 configured to engage with and/or in at least one groove and/or at least one track 36, which may be the above-mentioned counter guide element of the body 10. The engagement member 32 may include, or may be configured as, at least one roller configured to roll along a surface of the groove/track 36. Alternatively, or additionally, the engagement member 32 may include, or may be configured as, at least one sliding surface configured to slide along a surface of the groove/track 36.

The groove(s) and/or track(s) 36 may be attached to one or more of the side panel(s) 31. The guide elements 28 may include an attachment member 40 for attaching the guide elements 28 to the door structure, in particular to the slat(s) 12.

The guide elements 28 of the door 8, e.g., those shown in FIG. 2, may be configured substantially identically. Alternatively, the guide elements 28 of the door 8 may have different configurations. In particular, the door 8 may be equipped with a plurality of different types of guide elements 28, e.g., at least a first of the guide elements 28 may include or be configured as a roller configured to roll along a surface of the groove/track 36 and at least a second of the guide elements 28 may include or be configured as a sliding surface configured to slide along a surface of the groove/track 36.

The door 8 shown in FIG. 2 may be configured to open vertically and/or horizontally.

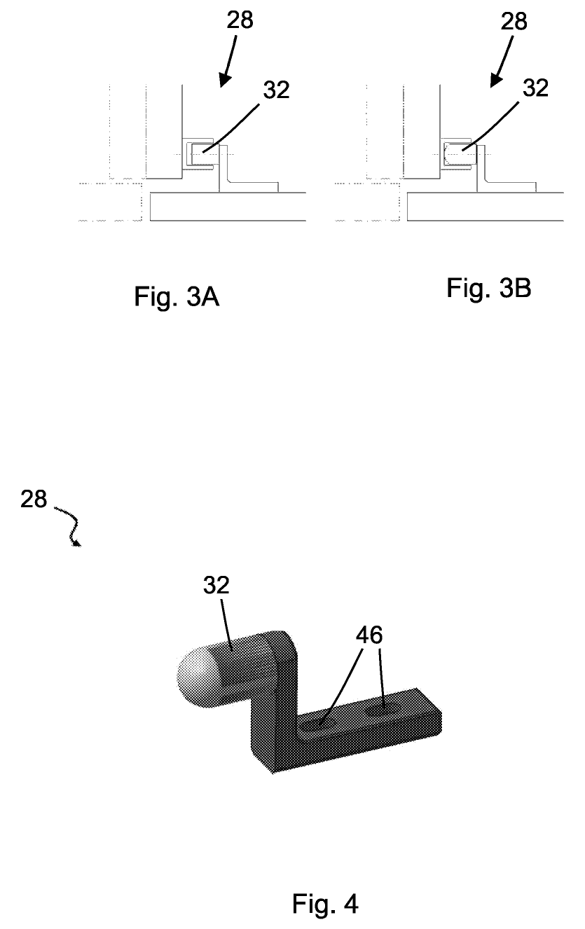

FIG. 3 shows two exemplary configurations of the guide elements 28. In particular according to FIG. 3A, the engagement member 32 of the guide element 28 may be substantially cylindrical shaped and/or may be substantially fixed, i.e., immovable, with respect to the door structure, more specifically the slats 12. Alternatively, the engagement member 32 of the guide element 28 may be moveable/adjustable, with respect to the door structure, more specifically the slats 12, e.g., by enabling the engagement member 32 to be adjusted/moved relative to one or more adjacent sections of the guide element 28 and/or to the slats 12. Alternatively, or additionally, the guide element 28 may have one or more elongated slots or openings 46 configured to receive one or more fastening elements, e.g., one or more screws, for fastening the guide element 28 to the door structure, in particular to the slats 12 (see FIG. 4). The elongated shape of the slots or openings 46 may allow a position of the guide element 28 relative to the groove/track 36 to be adjusted.

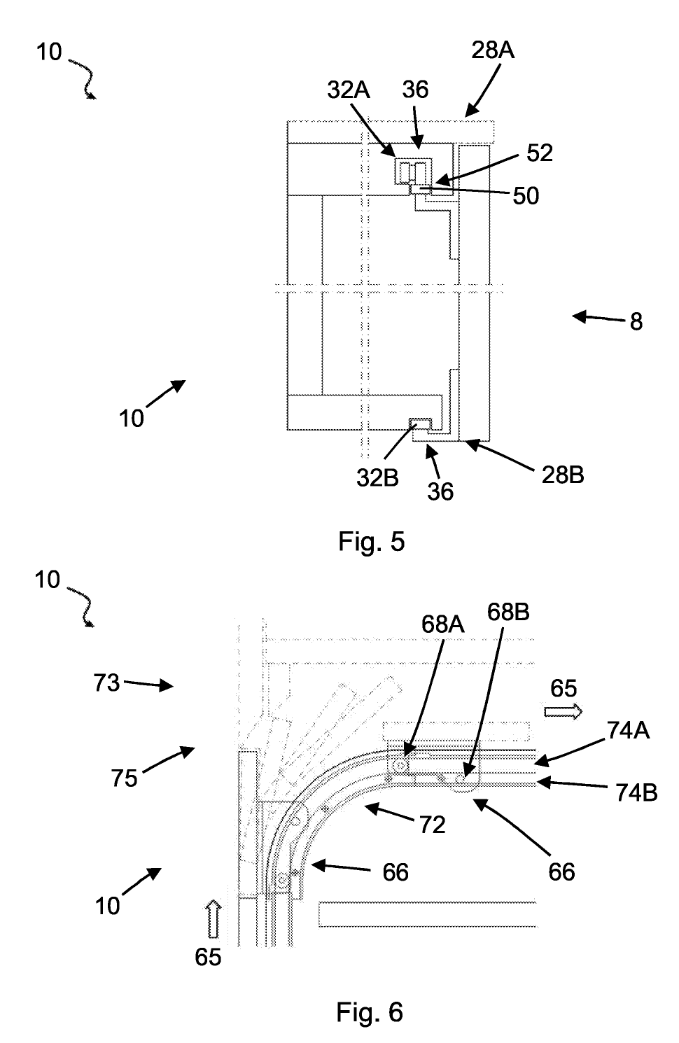

FIG. 5 shows an example of the door 8 having different guide elements 28. In particular, the door 8 may have at least one first guide element 28A of a first type and at least one second guide element 28B of a second type. The first guide element 28A may be arranged at or towards a first end, e.g., a top end, of the door 8, and the second guide element 28B may be arranged at or towards a second end, e.g., a lower end, of the door 8, the first end preferably being substantially opposite from the second end. The engagement member 32A of the first guide element 28A and/or the engagement member 32B of the second guide element 28B may be configured, or may include, at least one roller configured to roll along a surface of the groove/track 36 and/or at least one sliding surface configured to slide along a surface of the groove/track 36.

Alternatively, or additionally, at least one of the guide elements 28, e.g., the guide element 28A as shown in FIG. 5, may have at least one enlarged section 50, i.e., compared with adjacent section(s) of the respective guide element 28. The enlarged section 50 may be configured to cooperate with and/or be received in the groove/track 36, in particular in a section 52 of the groove/track 36 which has a cross-section adapted to the enlarged section 50, e.g., such that there is little to no play between the section 52 of the groove/track 36 and the enlarged section 50 to provide a smoother opening and closing operation of the door 8.

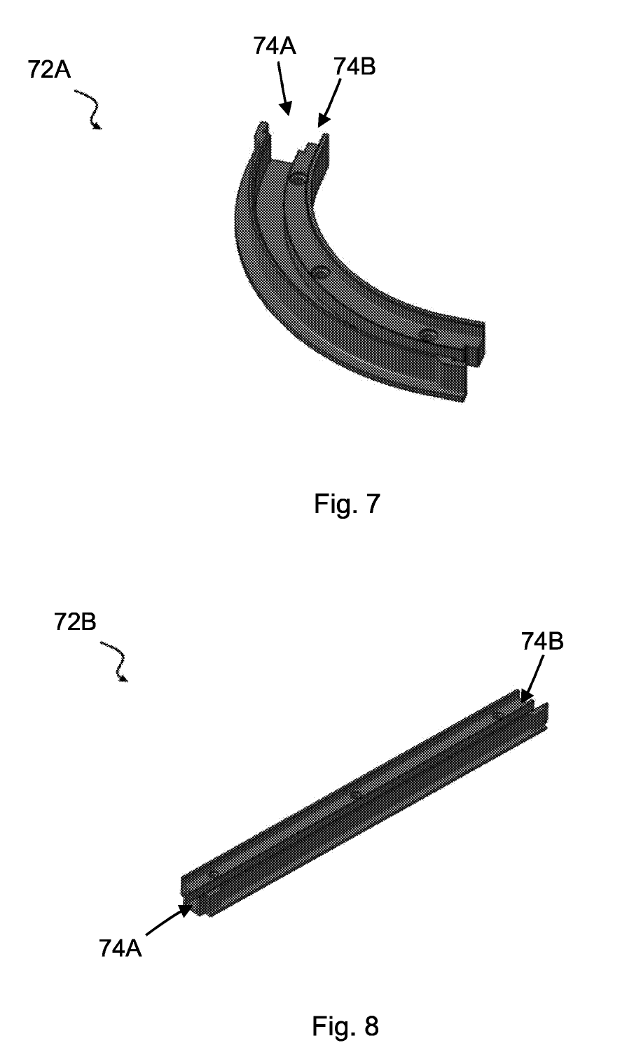

FIG. 6 shows a further embodiment of the door 8, in particular in which the door 8 is opened and closed vertically. In particular, FIG. 8 shows an opening movement of the door 8, as indicated by the arrows 65 and the depiction of the door structure in dashed lines in FIG. 6. The door 8 may include at least one guide element 66 which has at least a first engagement member 68A and a second engagement member 68B which engage with at least one counter guide element 72, in particular with at least two grooves or tracks 74 of the counter guide element 72. The counter guide element(s) 72 is/are shown in more detail in FIGS. 7 and 8.

The counter guide element 72 may have at least one first groove or track 74A and at least one second groove or track 74B, the first groove or track 74A preferably being arranged closer to the door 8 than the second groove or track 74B, when the door 8 is mounted to the body. The first engagement member 68A may be configured to engage with and/or be received by the first groove or track 74A, preferably permanently, when the door 8 is mounted to the body 10 and/or when the door 8 is being opened and/or closed. The second engagement member 68B may be configured to engage with and/or be received by the first groove or track 74A and/or the second groove or track 74B, when the door 8 is mounted to the body 10 and/or when the door 8 is being opened and/or closed. Preferably, the guide element 66 is configured such that the second engagement member 68B is movable from the first groove or track 74A to the second groove or track 74B and/or vice versa, when the door 8 is being opened and/or closed, preferably when the guide element 66 moves along a curved and/or bent path, as shown in FIG. 6.

One or more of the guide elements 66 of FIG. 6 may be arranged only at or along a top end of the door 8 and/or at or along a bottom end of the door 8. The door 8 may also include a plurality of the guide elements 28 of any of FIGS. 1 to 5 therebetween, e.g., between the top end and the bottom end of the door 8.

FIG. 6 also shows, in exemplary manner, that a top front panel 73 may be provided which is arranged towards or at a top of the body 10. Preferably, a lower side 75 of the top front panel 73 is arranged adjacent to a top side of the door 8, when the door 8 is in a closed position. Preferably, the lower side 75 of the top front panel 73 is beveled, preferably such that a front portion of the lower side 75 of the top front panel 73, which faces towards the exterior of the body 10, extends further towards a bottom of the body 10 than a back portion of the lower side 75 of the top front panel 73, which faces towards the interior of the body 10, when the door 8 and the body 10 are in an operating position. This may (further) enhance the aesthetic appeal of the door 8 and body 10.

FIG. 7 shows a first counter guide element 72A which may be configured for use along curved and/or bent paths, e.g., the curved path shown in FIG. 6. FIG. 8 shows a second counter guide element 72B which may be configured for use along substantially straight paths. As shown in FIGS. 7 and 8, the first groove or track 74A and the second groove or track 74B may be arranged at different heights/levels. The same applies to the first engagement member 68A and the second engagement member 68B accordingly. This may allow or aid in enabling the second engagement member 68B to move from the first groove or track 74A to the second groove or track 74B and/or vice versa and to maintain the first engagement member 68A in the first groove or track 74A, when the door 8 is being opened and/or closed, preferably when the guide element 66 moves along a curved and/or bent path, as discussed above.

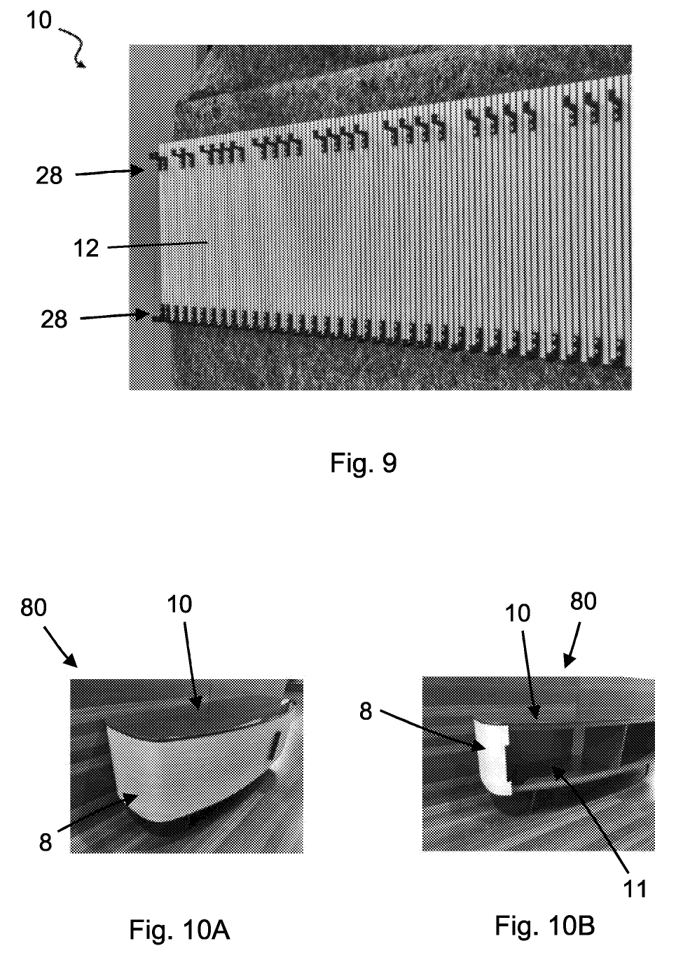

FIG. 9 shows a perspective and schematic view of the door 10 with the slats 12 and the guide elements 28. As shown in FIG. 9, a first row of guide elements 28, e.g., arranged along a top end of the door 8, may have a different number of guide elements 28 and/or a different distribution of guide elements 28 than a second row of guide elements 28, e.g., arranged along a bottom end of the door 8.

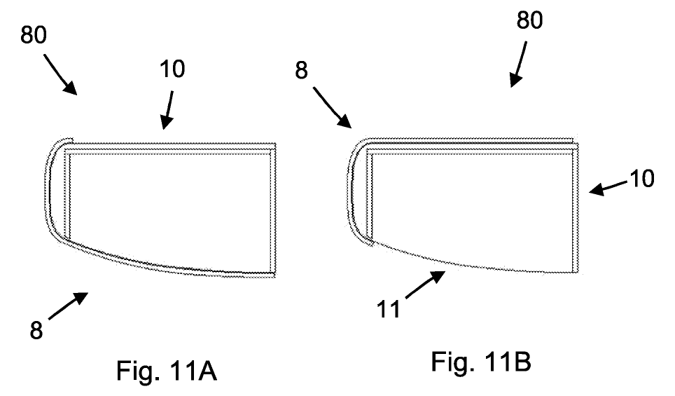

FIGS. 10 and 11 show a compartment 80 which may include at least one body, e.g., the body 10 described above, and at least one opening defined in the body 10. The compartment 80 may further include at least one door, e.g., the door 8 described above, which is slidably attached to the body 10 to slidably open and close the opening.

The compartment 80 may be configured as a piece of furniture, e.g., a cabinet, preferably a kitchen cabinet and/or an office cabinet, preferably a cabinet of an aircraft and/or a watercraft. FIGS. 10A and 11A show the compartment 80 in a closed state, i.e., in which the door 8 has been closed. FIGS. 10B and 11B show the compartment 80 in an open state, i.e., in which the door 8 has been opened. As shown in FIG. 11B, the compartment 80, specifically the door 8, may be configured such that, when opening the door 8, the door 8 is slid at least partially behind the body 10, i.e., to a side of the body which faces away and/or opposite from the opening 11 in the body 10, i.e., the opening 11 which is closed by the door 8.

The door 8 of the compartment 80 of FIGS. 10 and 11 may be configured according to any of the embodiments described herein and is not limited to a specific embodiment.

Any of the embodiments described above may be combined.

1. A door configured to be slidably attached to a body to slidably open and close at least one opening defined in the body, the door comprising:
a plurality of slats;
at least one connecting layer which is at least partially flexible and has a first side, which faces an interior of the body, and a second side, which faces an exterior of the body, when the door is attached to the body, the first side being substantially opposite from the second side, wherein the slats are fixedly attached to the first side of the connecting layer;
at least one outer layer which is at least partially flexible, wherein the outer layer is fixedly attached to the second side of the connecting layer; and
at least one guide element which is connected to at least one of the slats and is arranged at least partially on a side of the slat(s) which faces the interior of the body, when the door is attached to the body, the guide element being configured to cooperate with at least one counter guide element of the body to guide the door, when the door is slidably opened or closed.

2. The door according to claim 1, wherein an inner side of each slat which faces the interior of the body is free of any interconnection to at least one adjacent slat.

3. The door according to claim 1, including a plurality of the at least one guide element, the plurality of guide elements being spaced apart from each other, wherein at least one of the following features is included:
wherein each of the guide elements is attached to one of the slats, respectively, and one or more of the slats are free of a guide element; and
a first guide element of the guide elements is attached to a first slat of the slats and a second guide element of the guide elements is attached to a second slat of the slats, wherein one or more slats arranged between the first slat and the second slat are free of a guide element.

4. The door according to claim 1, wherein the connecting layer includes one or more layers which include(s) one or more of the following: at least one layer of foam, at least one layer of fabric, a cloth, a unidirectional cloth, a non-woven veil, at least one layer of textile, at least one laminate layer, and a material which includes at least one of synthetic fibers, natural fibers, linen fibers, cotton fibers, cellulose fibers, viscose fibers, acrylic fibers, polypropylene fibers, polyamide fibers and polyester fibers.

5. The door according to claim 1, wherein the connecting layer is made of one or more of the following materials, which are arranged in layers: a foam, an acrylic foam, a soft or flexible foam, a foam material based on one or more polyolefins, at least one of polyethylene (PE), polypropylene (PP), an acrylate, polyurethane (PU), polyvinyl chloride (PVC), nitrile butadiene rubber (NBR), a blend of PVC and NBR, one or more polyester variants, nitrile butadiene rubber, any other thermoplastic foam, a double-sided adhesive foam, and a laminate.

6. The door according to claim 1, wherein the guide element(s) is/are arranged completely on the side of the slat(s) which faces the interior of the body, at least when the door is in a closed position.

7. The door according to claim 1, wherein at least one of the following applies:
a lateral edge of at least one of the slats, the connecting layer, and the outer layer extends beyond the guide element(s), in at least one of an opening direction and a closing direction of the door; and
a lateral edge of at least one of the slats, the connecting layer, and the outer layer extends beyond the guide element(s), in a direction which is substantially perpendicular to at least one of an opening direction and a closing direction of the door.

8. The door according to claim 1, wherein the guide element(s) extend(s) from the side of the slat(s) which faces the interior of the body towards or into the interior of the body, when the door is attached to the body.

9. The door according to claim 1, wherein the door or the guide elements is/are configured such that a front surface of the door, which faces the exterior of the body, when the door is attached to the body, is substantially flush with one or more front surfaces of the body which face the exterior of the body or wherein each guide element includes at least one engagement member configured to engage with the counter guide element, wherein the engagement member is configured to at least one of slide and roll on at least one surface of the counter guide element, while opening or closing the door.

10. The door according to claim 1, wherein the outer layer is configured as a single continuous or seamless layer which covers each of the slats.

11. The door according to claim 1, wherein the outer layer is made of at least one of the following: wood, a wooden veneer, plastic, a least one fiber reinforced plastic, at least one leather, at least one synthetic leather, at least one textile, at least one fabric, at least one composite material, at least one laminate, at least one metal, at least one foil, at least one plastic foil, at least one metal foil, at least one stone, at least one cardboard, at least one paper, at least one fiber composite, at least one carbon fiber or glass fiber or plant based fiber composite, and at least one color painting.

12. The door according to claim 1, wherein the door includes at least one flame retardant provided in one or more components of the door.

13. The door according to claim 1, wherein the slats are made of at least one of the following: wood, plywood, solid wood, at least one plastic, at least one foam, at least one metal, and at least one composite material.

14. The door according to claim 1, wherein each slat includes at least two ends, which are made of wood or plywood, and at least one intermediate section which interconnects the ends, wherein the intermediate section is made at least partially of a non-wooden material or at least one foam.

15. The door according to claim 14, wherein the ends are made of a material which has a greater density than a material which the intermediate section is made of.

16. The door according to claim 1, wherein each slat is at least partially made of a composite material which includes at least one core and at least one cover layer which at least partially covers the core, wherein the core is made of a material which has a density which is lower than a density of a material which the cover layer is made of, wherein the core is at least partially made of at least one foam and the outer layer is at least partially made of wood, plywood, a laminate, a high pressure laminate, a continuous pressed laminate, a metal, aluminum, at least one fiber based composite, glass fiber, carbon fiber, and plant fiber based composite.

17. The door according to claim 1, wherein the outer layer is at least partially covered by at least one coating selected from one or more of the following: at least one color coating, at least one clear coating, at least one oil, a linseed oil, soybean oil, at least one acrylic coating, and at least one polyurethane coating.

18. A compartment comprising at least one body and at least one opening defined in the body, the compartment further including at least one door according to claim 1 which is slidably attached to the body to slidably open and close the opening.

19. A method for manufacturing a door configured to be slidably attached to a body to slidably open and close at least one opening defined in the body, the method comprising:
attaching a plurality of slats to a first side of a connecting layer which is at least partially flexible, wherein the first side faces an interior of the body, when the door is attached to the body;
attaching at least one outer layer, which is at least partially flexible, to a second side of the connecting layer, wherein the second side is substantially opposite from the first side and faces an exterior of the body, when the door is attached to the body; and
attaching at least one guide element to an inner side of at least one of the slats, the inner side facing the interior of the body, when the door is attached to the body, the guide element being configured to cooperate with at least one counter guide element of the body to guide the door, when the door is slidably opened or closed.

20. The method according to claim 19, further comprising:
providing a frame, the frame having an opening defined therein;
arranging at least one insert made of at least one solid material within the opening of the frame;
attaching at least one of the connecting layer and the outer layer to the frame and the insert to interconnect the frame and the insert; and
removing sections of the frame and the insert such that the remaining sections of the frame and the insert form the slats which are interconnected by the connecting layer.
